(19) United States
(12) Patent Application Publication
(10) Pub. No.: US 2014/0097157 A1
(43) Pub. Date: Apr. 10, 2014

(54) COMBINED METHOD FOR DRILLING A LAYER SYSTEM, IN WHICH MECHANICAL WORKING AND EDM WORKING ARE PERFORMED

(71) Applicant: Hans-Thomas Bolms, Mulheim an der Ruhr (DE)

(72) Inventor: Hans-Thomas Bolms, Mulheim an der Ruhr (DE)

(21) Appl. No.: 14/036,487

(22) Filed: Sep. 25, 2013

(30) Foreign Application Priority Data
Oct. 8, 2012 (EP) 12187615.5

(51) Int. Cl. B23H 5/04; B23B 27/00

(52) U.S. Cl. CPC B23H 5/04; B23B 27/00
USPC 219/69.17; 408/1 R; 408/27

(57) ABSTRACT

A method including mechanical removal and electrical discharge machining (EDM) working allowing symmetrical or asymmetrical holes to be produced with exact contours in a layer system including a metallic substrate and a non-metallic outermost layer is provided. In a first step, an outer region of the hole is worked by mechanical removal. In a final method step, when the underlying substrate or a metallic adhesion promoting layer has been reached an electrical discharge machining tool is used.

The present application claims priority to European Patent Office application No. 12187615.5 EP filed Oct. 8, 2012, the entire content of which is hereby incorporated herein by reference.

### FIELD OF INVENTION

The invention relates to a method for producing a hole in a layer system, in which first a mechanical method of removal and then an EDM method of removal is used.

### BACKGROUND OF INVENTION

Layer systems, such as are used in the case of gas turbine components, which have a metallic substrate, a metallic adhesion promoting layer and an outer ceramic layer, must be worked to produce cooling-air bores. The EDM working of non-conducting materials, such as for example the ceramic thermal barrier coatings on the gas turbine components, is complex, and in many cases a laser method is not possible for removing ceramic material on account of geometrical conditions of the component.

### SUMMARY OF INVENTION

Therefore, the object of the invention is to present a method that displays an improved procedure for producing holes in a layer system in which an outer peripheral region cannot be worked by means of EDM.

The object is achieved by a method according to the claims.

Further advantageous measures are listed in the dependent claims and can be combined with one another in any way desired to achieve further advantages.

### BRIEF DESCRIPTION OF THE DRAWINGS

In the drawings:

FIGS. 1, 2 and 3 schematically show the sequence of the method according to the invention;

FIG. 4 shows a list of superalloys.

The description of the figures only presents exemplary embodiments of the invention.

### DETAILED DESCRIPTION OF INVENTION

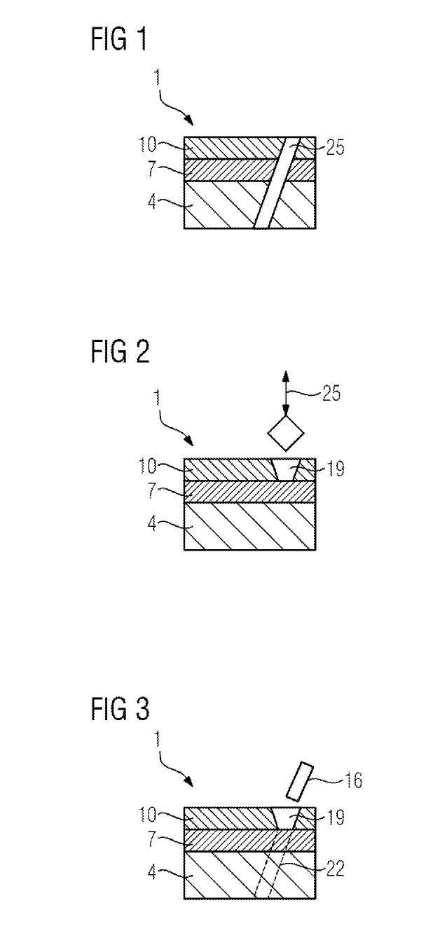

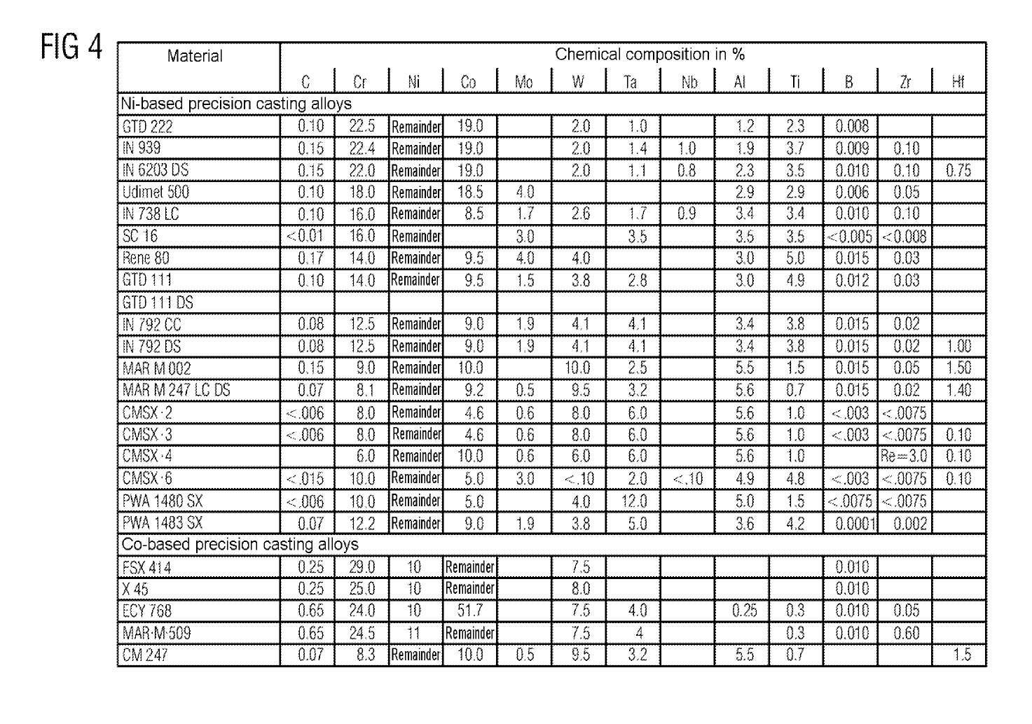

In FIG. 1, a layer system 1 that is intended to be worked by the method according to the invention is shown. The layer system 1 has a substrate 4, which is metallic, or at least can be worked by EDM working, and in the case of gas turbine components comprises a nickel- or cobalt-based alloy, in particular according to FIG. 4. Optionally present on the substrate 4 is a metallic adhesion promoting layer 7, which preferably comprises an NiCoCrAlY alloy.

On the substrate 4 and the metallic adhesion promoting layer 7 there may possibly be a thermally grown aluminum oxide (TGO) (not represented), but there is in any case, as an outermost layer, a ceramic layer 10 or such a hard material layer that cannot be worked by means of EDM.

In the case of gas turbine components, the material of the ceramic layer 10 is preferably a pyrochlore-, perovskite- or zirconia-based material.

A hole, preferably a through-hole 25, is to be created through this layer system, starting from the outermost layer 10.

As shown in FIG. 1, this involves removing material of the outermost layer 10 by a diamond. This preferably takes place by vibrating a diamond, the diamond being moved over the surface. Variations of relative movements of the substrate and the diamond are possible.

FIG. 2 already shows the region 19 that has been produced by the diamond 25.

The region 19 preferably has an asymmetrical structure, as is known from cooling-air bores with shapes, known as a diffuser, and is produced with its final contour.

For further working to produce the “metering hole” or the symmetrical through-hole 22 of the hole 25, an EDM electrode 16 is used, which electrode can be led through the diffuser region 19 or the ceramic layer region 13 and can remove material through the optionally present metallic adhesion promoting layer 7 and the substrate 4, since these are electrically conductive and are accessible to the EDM method or similar methods.

There is no need for any further re-working by means of a laser, in particular of the diffuser 19, for finishing.

We claim:

1. A method for producing a hole in a layer system, comprising:
providing the layer system with a metallic substrate and an outermost layer, wherein the outermost layer is electrically non-conductive, so that the outermost layer cannot be worked by means of an electrical discharge machining (EDM) method;
working an outer region of the hole by mechanical removal wherein material is removed from the layer in the outer region by a diamond; and
using an electrical discharge (EDM) electrode or electronic tool when the underlying substrate or an a metallic adhesion promoting layer has been reached in order to create a remaining part of the hole.

2. The method as claimed in claim 1, wherein the diamond is moved in a vibrating manner over the surface of the outermost layer.

3. The method as claimed in claim 1, wherein the method is applied at the locations of a layer system at which a laser beam is not accessible on account of the concave curvature of a surface.

4. The method as claimed in claim 1, wherein the outermost layer is ceramic.

5. The method as claimed in claim 4, wherein the outermost layer comprises zirconia, pyrochlore or a perovskite.

6. The method as claimed in claim 1, wherein the layer system consists of
a metallic substrate,
a metallic adhesion promoting layer,
an oxide layer on the substrate or on the adhesion promoting layer, and
a ceramic layer.

7. The method as claimed in claim 1,
wherein an outer region of the hole is produced completely by the diamond.

8. The method as claimed in claim 7, wherein the outer region of the hole is produced in a shape of an asymmetrically formed diffuser.

9. The method as claimed in claim 1, wherein no further re-working is performed after the diamond and electrical discharge machining (EDM) working
